(19) United States
(12) Patent Application Publication
(10) Pub. No.: US 2018/0260824 A1
(43) Pub. Date: Sep. 13, 2018

(54) INTEGRATED SERVICE DISCOVERY SYSTEMS AND METHODS

(71) Applicant: First Data Corporation, Greenwood Village, CO (US)

(72) Inventors: Christopher L. Toomer, Castle Rock, CO (US); Steven E. Arthur, Castle Rock, CO (US)

(73) Assignee: First Data Corporation, Greenwood Village, CO (US)

(21) Appl. No.: 15/979,940

(22) Filed: May 15, 2018

Related U.S. Application Data
(63) Continuation of application No. 11/925,181, filed on Oct. 26, 2007, now abandoned.

(51) Int. Cl. G06Q 30/02; G06Q 30/06

(52) U.S. Cl. CPC G06Q 30/02; G06Q 30/0601; G06Q 30/06; G06Q 30/0226; G06Q 30/0215

(57) ABSTRACT

A method of providing content to users includes, at a host computer, receiving a user-initiated request for the content. The request relates to specific service discovery-enabled media and the request includes an identifier. The method also includes using the identifier to locate the content, and providing the content to the user. The method also includes receiving at the host computer one of a user-initiated request to settle a transaction using a previously-identified account, a request to credit a purchase to a previously-identified loyalty program account, and a request to purchase an item from a specific merchant. The method also includes taking an action consistent with the second-listed receiving step.

### CROSS-REFERENCES TO RELATED APPLICATIONS

This application is a continuation of U.S. patent application Ser. No. 11/925,181, filed Oct. 26, 2007, entitled “INTEGRATED SERVICE DISCOVERY SYSTEMS AND METHODS,” the entire disclosure of which is incorporated herein by reference for all purposes.

This application is related to the following co-pending, commonly-assigned U.S. patent applications, the entirety of each of which are incorporated herein by reference for all purposes: U.S. patent application Ser. No. 11/864,231, filed Sep. 28, 2007, entitled “Service Discovery Via Mobile Imaging Systems And Methods”; U.S. patent application Ser. No. 11/830,409, filed Jul. 30, 2007, entitled “Marketing Messages In Mobile Commerce”; U.S. patent application Ser. No. 11/830,336, filed Jul. 30, 2007, entitled “Mobile Communication Systems And Methods For Redeeming And Reporting Coupons”; and U.S. patent application Ser. No. 11/830,459, filed Jul. 30, 2007, entitled “Payments Using A Mobile Commerce Device.”

### FIELD OF THE INVENTION

Embodiments of the present invention relate generally to mobile devices. More specifically, embodiments of the invention relate to systems and methods for using mobile devices in integrated service discovery applications.

### BACKGROUND OF THE INVENTION

Mobile devices have enabled interesting developments in the field of marketing. For example, advertisements may include technology that allows RF/NFC-enabled devices to acquire information from the advertisement for later use. Tremendous potential exists, however, for additional applications such as those described herein.

### BRIEF SUMMARY OF THE INVENTION

Embodiments of the present invention provide a method of providing content to users. The method includes, at a host computer, receiving a user-initiated request for the content. The request relates to specific service discovery-enabled media and the request includes an identifier. The method also includes using the identifier to locate the content, and providing the content to the user. The method also includes receiving at the host computer one of a user-initiated request to settle a transaction using a previously-identified account, a request to credit a purchase to a previously-identified loyalty program account, and a request to purchase an item from a specific merchant. The method also includes taking an action consistent with the second-listed receiving step.

In some embodiments, the media is electronic media, print media, a food service menu, a food label, a billboard, a television program or the like. The method may include enrolling the user prior to receiving the user-initiated request for the content. Enrolling the user may include providing application software programmed to configure a mobile device of the user to request the content. Enrolling the user may include receiving an identifier of a loyalty program account of the user, in which case the method may include receiving a request to credit a purchase to the loyalty program account. Enrolling the user may include providing the user an opportunity to identify interests, in which case using the identifier to locate the content may include using the interests, at least in part, to select the content.

Other embodiments provide a method of providing content to a user. the method includes enrolling a user, enrolling at least a merchant or a presentation instrument issuer, designing service discovery-enabled media, associating content with the service discovery enabled media, deploying the service discovery enabled media, receiving a user-initiated request for the content associated with the media, wherein the request originates with the user, and providing the content to the user.

The method may include receiving a user-initiated request originated by the user to purchase an item from a specific merchant. The method may include receiving a request originated by the user to settle a transaction using an account of the user issued by the issuer. Enrolling a user may include receiving an identifier of a loyalty program account of the user, in which case the method may include receiving a request to credit a purchase to the loyalty program account. The method may include receiving a request initiated by the user to purchase an item from a merchant, receiving a request to settle the purchase to a presentation instrument of the user issued by the issuer, and receiving a request to credit the purchase to the loyalty program account. The media may include electronic media, print media, a food service menu, a food label, a billboard, a television program, or the like. Enrolling a user may include providing the user an opportunity to identify a merchant as a merchant that the user patronizes or desires to patronize, providing the user an opportunity to provide an account identifier associated with a presentation instrument issued by an issuer, and providing the user an opportunity to identify one or more loyalty program account identifiers. Enrolling a user may include providing the user an opportunity to identify interests, in which case providing the content to the user may include using the interests, at least in part, to select the content.

Still other embodiments provide a service discovery system. The system includes at least one media item enabled to provide access to service discovery content, a processor, and a network connection through which the processor receives service discovery content requests from mobile devices of users. The processor is programmed to receive a user-initiated request for the content. The request relates to the media item and the request includes an identifier. The processor is also programmed to: use the identifier to locate the content; provide the content to the user; receive a user-initiated request to settle a purchase transaction using a previously-identified account, a request to credit a purchase to a previously-identified loyalty program account, and/or a request to purchase an item from a specific merchant; take an action consistent with the received request.

In such embodiments, the media may include electronic media, print media, a food service menu, a food label, a billboard, a television program, and/or the like. The system may include an enrollment system configured to provide application software programmed to configure a mobile device of the user to request the content. The enrollment system may be further configured to receive an identifier of a loyalty program account of the user and the processor may be programmed to process a request to credit a purchase to the loyalty program account. The enrollment system may be further configured to provide the user an opportunity to identify interests and the processor may be programmed to use the interests, at least in part, to select the content.

Still other embodiments of the present invention provide a method of receiving content associated with media. The method includes using a mobile device to acquire an image from media. The image has corresponding content. The method also includes using the mobile device to process the image to thereby produce the content and displaying at least a portion of the content on a display of the mobile device.

In some embodiments, using a mobile device to acquire an image from media includes using a camera-enabled mobile phone to acquire an image of a portion of an advertisement. Using the mobile device to process the image to thereby produce the content may include using an application residing on the mobile device to process the image to produce the content. The software application may include optical character recognition software. The software application may include pattern recognition software. Using the mobile device to process the image to thereby produce the content may include sending the image to a server and receiving output representative of the content from the server. Using the mobile device to process the image to thereby produce the content may include using an application residing on the mobile device to produce a link to the content and using the link to direct a browser on the mobile device to a server having the content. The media may include print media such as a poster advertisement, a publication advertisement, a food label, a restaurant menu, a business card, and/or the like. The media may include electronic media such as a television commercial, an electronic billboard, a television show, a computer-generated display image, and/or the like. The content may be a 2-D bar code, a 3-D bar code, a design, a picture, a URL, an ISBN; text, and/or the like.

Other embodiments provide a computer-readable medium having computer-executable instructions thereon. The instructions are configured to configure a mobile device to capture an image, process the image to produce content, and display at least a portion of the content on the mobile device.

In some embodiments the computer-executable instructions are further configured to process the image to produce content by sending the image to a server and receiving output representative of the content from the server. The computer-executable instructions are further configured to process the image to produce content by producing a link to the content and using the link to direct a browser on the mobile device to a server having the content.

Other embodiments provide a method of receiving content associated with media. The method includes acquiring a software application programmed to configure a mobile device to acquire and process images, enabling the mobile device to acquire the images, acquiring an image from media, using the software application to process the image into content, displaying at least a portion of the content on a display associated with the mobile device, and transmitting at least a portion of the content to a point-of-sale device to thereby receive a benefit.

In some embodiments acquiring an image from media comprises using a camera-enabled mobile phone to acquire an image of a portion of an advertisement. The software application may include optical character recognition software. The software application may include pattern recognition software. Using the mobile device to process the image to thereby produce the content may include sending the image to a server and receiving output representative of the content from the server. Using the mobile device to process the image to thereby produce the content may include using an application residing on the mobile device to produce a link to the content and using the link to direct a browser on the mobile device to a server having the content. The media may include print media such as a poster advertisement, a publication advertisement, a food label, a restaurant menu, a business card, and/or the like. The media may include electronic media such as a television commercial, an electronic billboard, a television show, a computer-generated display image, and/or the like. The content may be a 2-D bar code, a 3-D bar code, a design, a picture, a URL, an ISBN; text, and/or the like.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an exemplary system within which embodiments of the invention may be implemented.

FIG. 2 depicts an exemplary method of integrated service discovery, which method may be implemented in the system of FIG. 1.

FIG. 3 depicts a second exemplary method of integrated service discovery, which method may be implemented in the system of FIG. 1.

FIG. 4 depicts a service discovery method according to embodiments of the invention, which method may be implemented in the system of FIG. 1.

FIG. 5 depicts a method of processing a captured image into content according to embodiments of the invention.

FIG. 6 depicts a method of processing a captured image into content according to embodiments of the invention, which method may be implemented in the server shown in FIG. 1.

### DETAILED DESCRIPTION OF THE INVENTION

Embodiments of the present invention relate to service discovery marketing. In order to provide a context for describing embodiments of the present invention, embodiments of the invention will be described herein with reference to using a cell phone to acquire service discovery information from deployed marketing materials that then direct customers to further experiences.

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It is to be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems may be shown in block diagrams in order not to obscure the embodiments in unnecessary detail. In other instances, well-known processes, structures and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

According to embodiments of the invention, a user (herein “customer,” “consumer,” and/or the like) uses a mobile device to acquire service discovery information from media. The term “service discovery” will be used herein to refer to interactive communication wherein a user/customer uses a properly-enabled device (e.g., mobile phone) to obtain supplementary information from media, such as print or electronic advertising. Upon acquisition of the service discovery information, the customer may then avail himself of a benefit provided by the service discovery information.

In some embodiments, the user may be directed to an electronic or brick-and-mortar store at which the customer may receive a benefit. For example, the service discovery information (herein “content”) may be a coupon that offers the customer a discount off of a purchase exceeding a dollar amount threshold. The content may alert the customer to a sale taking place at a particular establishment. In still other embodiments, the content may alert the customer to an event consistent with the user's interests, enabled by the user having previously registered, enrolled, opted-in, or otherwise requested to receive particular service discovery information by having identified his interests or the like.

According to exemplary embodiments, an organizer (e.g., a transaction processor) enrolls merchants, presentation instrument issuers, consumers (of the merchant or issuer), and/or the like into a service discovery program. Merchants or issuers provide content which may be deployed in relation to media, advertising, or the like. The advertising may be merchant-specific advertising (e.g., an advertisement specific to the merchant's products and/or services), geographic or location-based advertising (e.g., advertising for a number of merchants in a common space—including virtual—, area, or region), synergistic advertising (e.g., merchants cooperating to advertise together), and/or the like. Presentation instrument issuers, branded card network operators and their customers, cellular network operators, and/or the like may elect to allow their presentation instruments (credit cards, debit cards, pre-paid cards, gift cards, cell phones, etc.) to be enrolled by the cardholder/customer into the service discovery program. Consumers are then able to create a profile within the service discovery program, enroll with particular merchants, identify personally-owned presentation instruments to use in settlement of transactions, provide loyalty program identifiers, identify their interests, and the like. Thereafter, the consumers may encounter media that calls attention to the service discovery program in which the consumer is enrolled. He may then acquire the content and avail himself of any offered benefit, including completing a purchase using a previously-identified presentation instrument account at a physical POS, a virtual POS, or through capabilities of the mobile device interacting with the content and/or the content's issuer. Those skilled in the art will appreciate a number of additional embodiments in light of the disclosure herein.

According to embodiments of the invention, a user uses a mobile device to acquire an image having content embedded therein. The user is thereafter able to use the image in an advantageous way. Is some embodiments, the image is from print media such as advertising (posters, gift cards, newspapers, magazines, or the like), magazine or newspaper articles, product labels, restaurant menus, and/or the like. In other embodiments, the image is from electronic media, such as electronic advertising, TV commercials, and/or the like. The content may be a bar code, a picture, a design, text, a URL, and/or the like. The mobile device may be a camera-enabled cell phone, digital still camera, video camera, scanner, or the like. The device may be configured to process the image and/or transmit the image to a different location for processing and receive the results. The mobile device may be enabled to take additional action based on the results of the processing. For example, the device may be configured to transmit information using Near Field Communication (NFC) technology or the like. The information may be transmitted to a point-of-sale (POS) device or the like.

In a specific embodiment, a user uses a camera-enabled mobile phone to acquire an image of a portion of an advertisement. In some embodiments, the user executes an application on the mobile device before acquiring the image. The application then processes the image using optical character recognition (OCR), field recognition software, or the like. The application then produces output that may be used by the device.

In some embodiments, the device transmits the image to a server. The server then processes the image or locates corresponding information in a database. The result is then returned to the mobile device.

Once the mobile device is in possession of the processed content, it may display the information to the user. The content may be, for example, a coupon, an advertising announcement, a sales offer, directions to a location, etc. As stated above, the mobile device also may transmit the content, using NFC or the like, to a properly enabled receiver, such as a POS or the like.

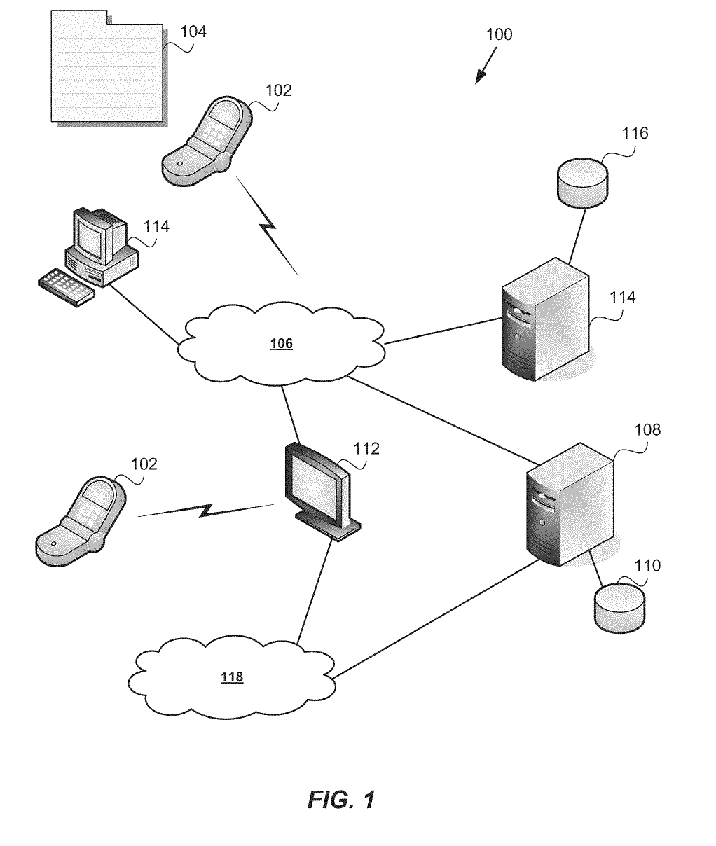

Having described embodiments of the present invention generally, attention is directed to FIG. 1, which depicts an exemplary service discovery system 100 according to embodiments of the present invention. Those skilled in the art will appreciate that the system 100 is merely exemplary of a number of possible embodiments. Within the system 100 of FIG. 1, a user may use a mobile device 102 to participate in a service discovery program. For example, the user may encounter service-discovery-enabled media 104 that emits service discovery information using RF/NFC (radio frequency, near field communication) technology or the like. Or as more fully described in previously-incorporated U.S. patent application Ser. No. 11/864,231, the user may use a properly-enabled mobile device to acquire an image that is thereafter processed to reveal service discovery content.

The device 102 may be any of a variety of devices (cell phone, PDA, hand-held computer, etc.) capable of processing service discovery information or interacting via a network 106 with a host computer 108 capable of processing the service discovery information. The media 104 may be any advertising (print, electronic, etc.), product labels, television shows, restaurant menus, or the like.

The host computer 108, having memory 110 associated therewith, may be any of a variety of computing devices. The host computer 108 provides service discovery processing capability to some mobile devices and may be configured to provide an enhanced service discovery experience in a number of embodiments as will be described in greater detail hereinafter.

The mobile device 102 is also capable of communication with a point-of-sale (POS) terminal 112. Hence, the user may acquire service discovery information from media 104 that directs the user to the POS terminal 112. The POS terminal may be physical or virtual.

The mobile device 102 may be any of a variety of image capture devices including cell phones, digital still cameras, personal digital assistants (PDAs), and the like. The captured image may include a bar code, a design, a message, an http web address, and/or the like.

The mobile device 102 may be configured to process a captured image into useful content. The content may be embedded into the captured image (e.g., bar coding), but this is not necessarily the case. For example, the mobile device 102 may be programmed to perform optical character recognition (OCR) and/or pattern recognition on the image to thereby produce the content. In some embodiments, the mobile device 102 is configured for wireless communication. If the device is so configured, the device may send the image through the network 106 to the host computer/server 108. The server 108 may be configured to receive the image and return corresponding content. In doing so, the server may perform OCR or pattern recognition or may match the image to a stored image to thereby identify the corresponding content. The content may be returned to the mobile device via the network 106.

According to embodiments of the present invention, a user may register to participate in the service discovery program described herein. For example, the user may use the mobile device 102 and/or a personal computer 114 to communicate with the host computer 108, which may be configured to register users. The user may download application software to thereby configure the mobile device 102, identify personal interests that may be used thereafter to “tailor” service discovery content for the user, identify merchants that the user patronizes, provide loyalty program identifiers for loyalty programs within which the user participates, enroll in loyalty programs, provide account numbers for presentation instruments (credit cards, debit cards, gift cards, stored value cards, etc.) that the user may wish to use to settle transactions, apply for and/or purchase presentation instruments, and the like.

According to some embodiments, the system also may include one or more loyalty program computers 114 and associated storage 116. When the user makes a purchase using an enrolled mobile device, then the user's loyalty account at the loyalty computer 114 may be credited or, in the case of using loyalty points to settle a purchase, debited.

The system also may include a transaction settlement network 118. The POS 112 may initiate settlements of transactions initiated by the user through this network.

In a specific example describing how the system 100 is used, a program sponsor/originator (e.g., a transaction processor), having relationships with many processing merchants, credit card issuers, and consumers, provides each of the aforementioned with an opportunity to enroll into a service discovery program. Merchants purchase advertising and provide content to be used in service discovery marketing. The sponsor may design advertising that integrates several merchants into advertising based on location, product synergy, and/or the like. The sponsor also enrolls credit card issuers who may wish to have their presentation instruments used in service discovery transaction settlement. The sponsor also enrolls customers desiring to participate in service discovery marketing who have a properly-enabled device 102 and/or who configure the device in the enrollment process.

Continuing with this example, service-discovery enabled media 104 is deployed. In this case, the media is a billboard in a train station. The media may have an identifying trademark indicating that the media is service-discovery enabled. A user notes that the billboard is service discovery enabled and acquires the associated content using his mobile device 102. In this case, the user acquires the content using NFC, although the content may be an image that the user captures via an image capture or recording device on the mobile device, such as a digital camera.

In this example, the service discovery content directs the user's mobile device to the host computer 108. The user's device identifies itself to the host computer, which locates an electronic record of the user. The electronic record includes previous activity of the user, including an indication that the user likes a particular brand of coffee and has purchased four coffees at this merchant in the last week. The host accesses a different electronic file that is associated with the merchant, and identifies a “buy five coffees, get one free” coupon associated with the merchant. The host computer 108 returns this offer to the user.

The user receives the offer and decides to purchase a coffee from the merchant at a location two blocks away. Conveniently, the offer sent to the user includes a link to an ordering function for this merchant location, so the user orders a coffee for pickup in five minutes. The user uses the coupon to order an additional coffee for his boss. The order is sent through the host computer to the merchant.

The host also recognizes that the user has provided a stored value card for this merchant. The host queries the user whether the transaction should be settled using this method. Upon the user affirming this, the host either settles the transaction directly, via the transaction processing network 118, or provides the user's account information to the merchant for settlement. Either way, the user arrives at the coffee shop and picks up his coffee without having to wait in line. The host also credits the user's loyalty account for the purchase. Those skilled in the art will appreciate that the foregoing example is merely exemplary of a number of possible embodiments of the present invention.

In a specific example, a user enrolls into a service discovery program and installs software on his cell phone (note that in other embodiments necessary applications may be pre-installed). The user encounters an advertisement that identifies itself as being within the service discovery program, specifically providing service discovery through mobile imaging. The user uses his cell phone to capture an image of a particular design from the advertisement. The design is specifically identified to the user for this purpose. The user then transmits the image to a server. The server uses the image and pattern recognition or the like to locate a database record corresponding to the image. The record includes content that the server returns to the user's cell phone. The content in then displayed and/or stored. In this particular example, the content directs the user to a nearby coffee shop at which the user will receive a discount upon presentation of the content. The user visits the coffee shop and, upon ordering, transmits the content to a POS at the coffee shop, receiving a discount.

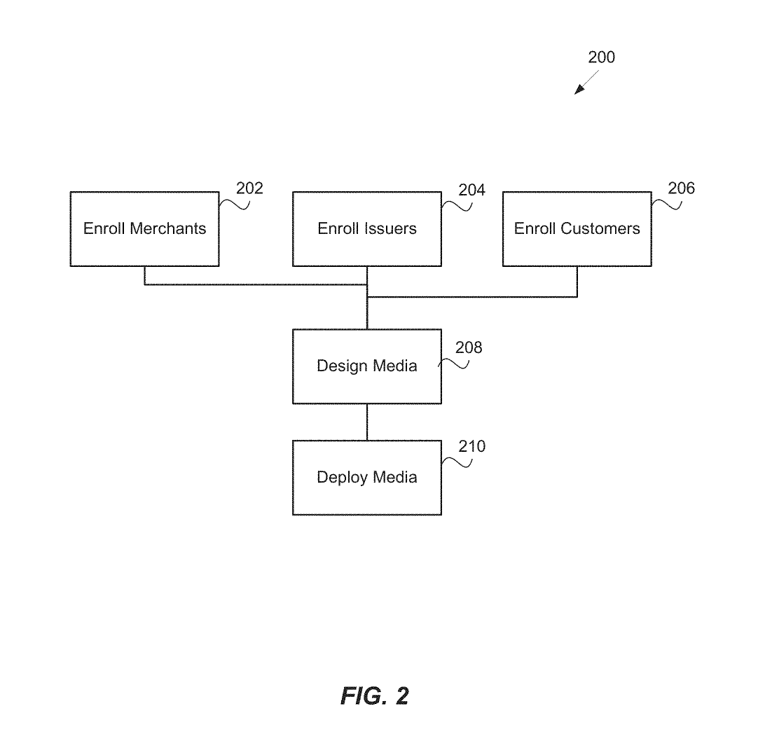

Having described an exemplary system 100 according to embodiments of the present invention and a specific example of the present invention using the system 100, attention is directed to FIG. 2, which depicts an exemplary method 200 according to embodiments of the invention. The method 200 relates to pre-use aspects of integrated service discovery. The method 200 may be implemented in the system 100 of FIG. 1 or other appropriate system. Those skilled in the art will appreciate that the method 200 is merely exemplary of a number of possible methods. Other methods according to other embodiments may have more, fewer, or different steps than those illustrated and described herein. Moreover, the steps depicted and described herein may be traversed in orders different than described here.

The method 200 begins with enrollment of merchants, issuers, and customers, which may take place simultaneously. Using any available marketing channel, a program sponsor solicits merchants at block 202. In the process of enrolling merchants, the sponsor solicits information on the merchant's locations, desired promotions, product offerings, and/or the like. The sponsor also enrolls issuers (block 204) of presentation instruments who wish to have their presentation instruments included in the service discovery program. The sponsor also enrolls customers at block 206.

In enrolling customers, the sponsor may provide an application to be installed on the user's mobile device, receive a listing of user interests, provide the user an opportunity to enroll presentation instruments and loyalty programs, and the like.

At block 208, the sponsor may design advertising to take advantage of the demographics of the enrolled pool of merchants, issuers, and customers. This may include designing and/or producing customer-specific service discovery content. Conveniently, the sponsor may use a rules engine or the like to control the delivery of content to specific users and associate this content with specific advertising. Those skilled in the art will appreciate may such examples in light of this disclosure.

At block 210, the media is deployed. As mentioned previously, the media may be print or electronic and may be deployed through any of a variety of marketing channels.

Those skilled in the art will appreciate that the method 200 is merely exemplary. Specifically, it is not necessary that the steps discussed herein be accomplished by a sponsor. The media may be deployed by a single merchant and relate to a single location of the merchant without involvement of other merchants, issuers, or sponsors.

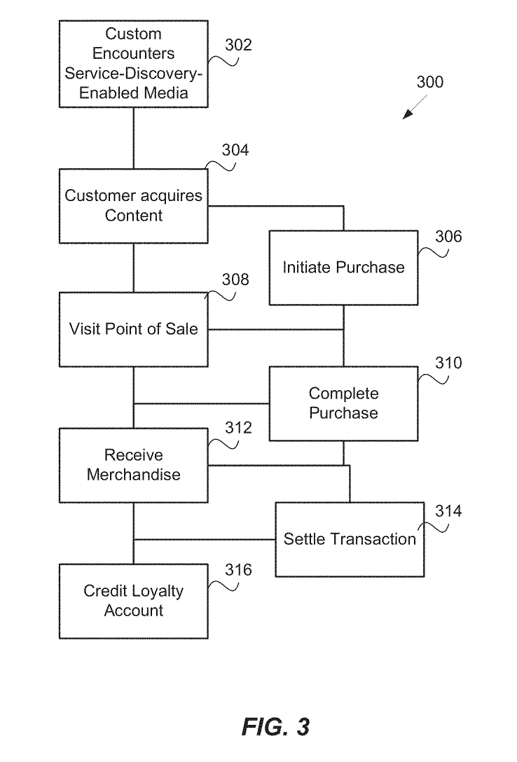

Attention is now directed to FIG. 3, which depicts a method of integrated service discovery according to embodiments of the present invention, which method may be embodied in the system 100 of FIG. 1. The method 300 begins at block 302 at which point a user encounters service-discovery enabled media. The user, at block 304, acquires the content from the media in any of the aforementioned methods. This may include interacting with a host computer that includes a user record. The content may be based on the user record.

In some cases, the user may elect to initiate a purchase at block 306. This may be enabled by the user being directed by the content to a web site of a merchant. In some cases, however, the service discovery application may itself initiate the purchase. For example, the content may present the user with a benefit at a merchant the user patronizes and may query the user whether the user wishes to place his usual order. Of course, many other possibilities exist.

In other cases, the user visits a point of sale based on the content at block 308. The user may then avail himself of a benefit provided by the content. The user may thereafter complete a purchase at block 310. At block 312, the user receives the product or service.

At block 314, the user's transaction may be settled using a previously-identified presentation instrument account of the user. At block 316, the user may receive credit at a previously-identified loyalty program. Those skilled in the art will appreciate that many additional possibilities exist.

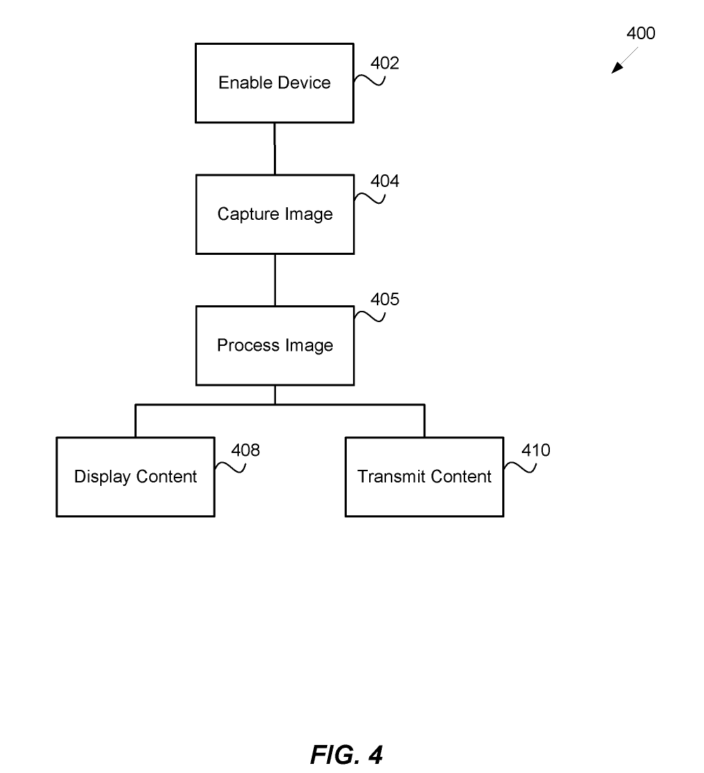

Having generally described some embodiments of the invention, attention is directed to FIG. 4, which depicts an exemplary method 400 according to embodiments of the invention. Those skilled in the art will appreciate that the method 400 is merely exemplary of a number of possible embodiments. Moreover, other examples according to other embodiments may have more, fewer, or different steps than those illustrated and described herein. Further, the blocks illustrated and described herein may be traversed in orders different than that shown. The method 400 may be implemented in the system 100 of FIG. 1 or another appropriate system.

The method 400 begins at block 402, at which location a user enables a mobile device. Enabling the mobile device may include any of a number of activities. For example, enabling the device may include downloading a software application for a particular service discovery provider, executing the application, enabling an image capture function of the device, and/or the like. In some embodiments, enabling the device may include simply powering the device on.

At block 404, the mobile device is used to capture an image. This can take many forms, but typically includes capturing an electronic image of a portion of a service discovery advertisement enabled for mobile imaging. In some embodiments, the image may include other than visual wavelengths (e.g., infrared imagery).

At block 406, the captured image is processed to access or produce content. The image may be processed by the mobile device or may be transmitted to a remote server for processing as will be described in greater detail below. At block 408, the content may be displayed on a display of the mobile device and/or the content may be transmitted to another device, a POS, or the like at block 410.

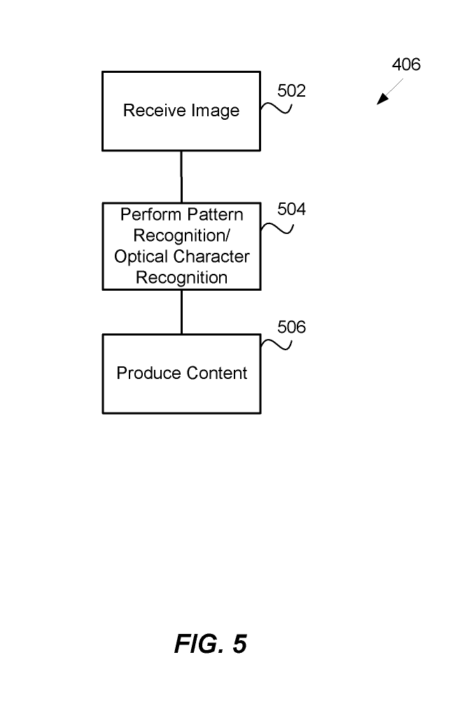

FIG. 5 depicts an embodiment of the image processing block 406 of FIG. 4 in greater detail. In this instance, the image processing is performed by the mobile device. A processor receives the image at block 502. Using, for example, a previously-downloaded software application, the processor performs OCR, pattern recognition, or the like at block 504. This produces content, as indicated at block 506. Other examples exist.

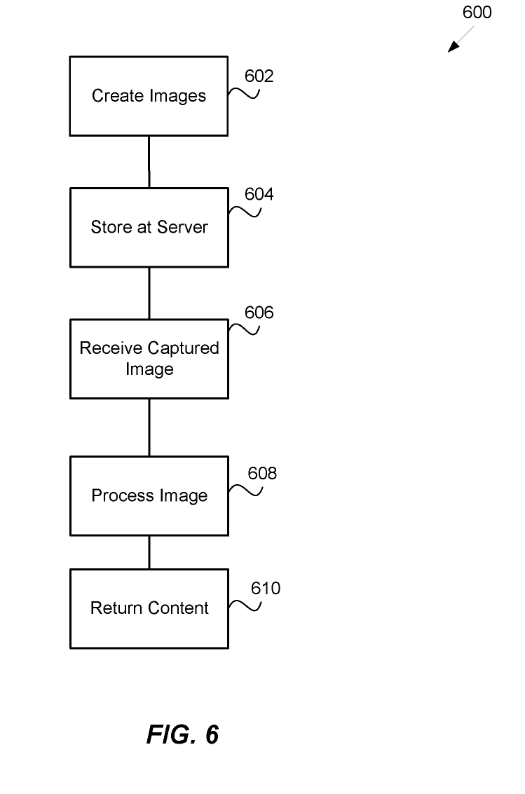

FIG. 6 depicts another exemplary method 600 in which image processing takes place at a remote server. In this embodiment, images to be deployed on advertising are created at block 602. As stated previously, the images may have embedded information (e.g., bar code, URL, and/or the like), which may direct the user's device to the correct source for the content, or the images may simply be used to locate corresponding content on the remote server. The images (or corresponding information) are stored on a server at block 604. The images may be stored in records with corresponding content to be returned to a user upon receiving a copy of the image from the user's mobile device. Advantageously, according to this embodiment, it is possible to change the content without having to redeploy the corresponding advertising.

At block 606, a captured image is received at the server. The image is processed at block 608, which may include using OCR and/or pattern recognition, locating a corresponding image in a database, using a lookup table, redirecting a browser on the user's device to a particular web site, and/or the like. Either way, processing the image produces content, and the content is returned to the user's mobile device at block 610.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. Accordingly, the above description should not be taken as limiting the scope of the invention, which is defined in the following claims.

1. (canceled)

2. A method of providing content associated with potential transactions to users, comprising:
at a host computer, receiving a captured image from a mobile device of a user, wherein the captured image relates to specific service discovery-enabled media received by an image capture device of the mobile device, the specific service discovery-enabled media comprising at least a portion of an advertisement, wherein the advertisement further includes identification information that identifies to the user that the purpose of the at least a portion of the advertisement is to permit the user to receive, under a program in which the user has previously enrolled and identified a user account, a discount for a subsequently ordered good or service associated with the advertisement;
at the host computer, processing the captured imaged of the specific service discovery-enabled media to locate the content, wherein the content comprises a coupon which will provide the discount for goods or services at a merchant;
from the host computer, providing the content to the mobile device of the user;
receiving at the host computer a user-initiated request to settle a transaction related to the content using the previously-identified user account; and
determining that the transaction is a purchase of the goods or services from the merchant, and applying the coupon to the transaction to create a discounted transaction; and
settling the discounted transaction, with the host computer, using the previously identified account.

3. The method of claim 2, wherein processing the captured image at the host computer comprises obtaining embedded information from the captured image to locate the content, by directing the mobile device to a source for the content.

4. The method of claim 3, wherein the embedded information comprises one of bar code.

5. The method of claim 3, wherein the embedded information comprises a URL.

6. The method of claim 2, wherein processing the captured image at the host computer comprises matching the captured image to a stored image at the host computer, with the content stored in association with the stored image.

7. The method of claim 2, wherein the media comprises a selection from a group consisting of electronic media, print media, food service menu, food label, billboard, and television program.

8. The method of claim 2, further comprising enrolling the user prior to receiving the user-initiated request for the content.

9. The method of claim 8, wherein enrolling the user comprises providing application software programmed to configure a mobile device of the user to request the content.

10. The method of claim 8, wherein enrolling the user comprises receiving an identifier of a loyalty program account of the user, the method further comprising receiving a request to credit the transaction to the loyalty program account.

11. The method of claim 8, wherein enrolling the user comprises providing the user an opportunity to identify interests, wherein receiving a captured image at the host computer is associated with a user-initiated request for the content from the mobile device, the user initiated request including an identifier identifying the user, and wherein the method further comprises using the identified interests, at least in part, to select the content.

12. A method of providing content associated with potential transactions to a user, comprising:
enrolling a user with a host computer;
enrolling a merchant with the host computer;
designing service discovery-enabled media;
associating, at the host computer, a plurality of merchant point of sale terminals with the service discovery enabled media;
associating content with the service discovery enabled media at the host computer;
deploying the service discovery enabled media, the service discovery-enabled media including at least a portion of an advertisement, wherein the advertisement further includes identification information that identifies to the user that the purpose of the at least a portion of the advertisement is to permit the user to receive a discount for a subsequently ordered good or service associated with the advertisement;
receiving, at the host computer, a user-initiated request for the content associated with the service discovery-enabled media from a mobile device having an image capture device, and wherein the request originates with the user, and wherein the request includes a captured image of the service discovery-enabled media received by the image capture device of the mobile device;
providing the content to the mobile device of the user, wherein the content comprises directions to a first point of sale terminal of the plurality of merchant point of sale terminals, wherein providing the content to the mobile device includes processing, at the host computer system, the captured imaged of the service discovery-enabled media to locate the content; and
receiving, at the host computer from the first point of sale terminal, a request to process a transaction between the user and the merchant for the good or service associated with the advertisement, where the transaction is based at least in part on the content, and applies the discount to the transaction.

13. The method of claim 12, wherein the method further comprises:
enrolling a presentation instrument issuer; and
settling the transaction using an account of the user issued by the presentation instrument issuer.

14. The method of claim 12, wherein enrolling a user comprises receiving an identifier of a loyalty program account of the user, the method further comprising receiving a request to credit the transaction to the loyalty program account.

15. The method of claim 12, wherein the media comprises a selection from a group consisting of electronic media, print media, food service menu, food label, billboard, and television program.

16. The method of claim 12, wherein the method further comprises:
enrolling a presentation instrument issuer;
providing the user an opportunity to identify the merchant as a merchant that the user patronizes or desires to patronize;
providing the user an opportunity to provide an account identifier associated with a presentation instrument issued by the issuer; and
providing the user an opportunity to identify one or more loyalty program account identifiers.

17. The method of claim 12, wherein enrolling a user comprises providing the user an opportunity to identify interests and wherein providing the content to the user comprises using the identified interests, at least in part, to select the content.

18. A service discovery system associated with potential transactions, comprising:
at least one media item that is service discover-enabled to provide access to service discovery content when captured by an image capture device of a mobile device, the service discovery-enabled media including at least a portion of an advertisement, wherein the advertisement further includes identification information that identifies to the user that the purpose of the at least a portion of an advertisement is to permit the user to receive a discount for a subsequently ordered good or service associated with the advertisement;
a processor; and
a network connection through which the processor receives service discovery content requests from mobile devices of users;
wherein the processor is programmed to:
receive a user-initiated request for the content, wherein the request includes a captured image of the service discovery-enabled media and an identity of a user;
use the captured image of the service discovery-enabled media to locate a plurality of content;
access a record related to the identity of the user, wherein the record includes a history of past purchases by the user;
select, based at least in part on the history of past purchases and the captured image, a coupon from the plurality of content;
provide the content to the user;
receive a user-initiated request to settle a purchase transaction related to the content using a previously-identified account; and
settle the transaction using the previously identified account and the coupon, such that the discount is applied to the transaction.

19. The system of claim 18, wherein the media comprises a selection from a group consisting of electronic media, print media, food service menu, food label, billboard, and television program.

20. The system of claim 18, further comprising an enrollment system configured to provide application software programmed to configure the mobile device of the user to request the content.

21. The system of claim 20, wherein the enrollment system is further configured to receive an identifier of a loyalty program account of the user and wherein the processor is further programmed to process a request to credit the transaction to the loyalty program account.

22. The system of claim 20, wherein the enrollment system is further configured to provide the user an opportunity to identify interests and wherein the processor is further programmed to use the identified interests, at least in part, to select the content.
